(19) United States
(12) Patent Application Publication
(10) Pub. No.: US 2007/0221728 A1
(43) Pub. Date: Sep. 27, 2007

(54) POS Receipt Bearing Real-Time Time/Geographic Advertisement

(75) Inventors: Jay Ferro, Santa Barbara, CA (US); Tariq Mufti, Ojai, CA (US)

Correspondence Address: PATENT LAW OFFICES OF MICHAEL E. WOODS, 3433 WHEELING DRIVE, SANTA CLARA, CA, 95051, US

(73) Assignee: Nutricate Corporation, Santa Barbara, CA (US)

(21) Appl. No.: 11/690,912

(22) Filed: Mar. 26, 2007

Related U.S. Application Data
(60) Provisional application No. 60/767,408, filed on Mar. 26, 2006.

(51) Int. Cl. G06K 15/00; G07G 1/14

(52) U.S. Cl. 235/383; 705/14

(57) ABSTRACT

An apparatus, method, system, and computer-program product for producing valuable POS indicia that provides value to both the customer and to the establishment. The apparatus includes a point-of-sale (POS) receipt including a first portion and a second portion, the first portion including a transaction memorialization information and the second portion including a localization token that has been generated, for example, by a process where the time, location and nature of transaction are the parameters used to select the specific contents of the token. The method includes processes for the manufacture, assembly and use of the disclosed system, with the computer program product including machine-executable instructions for carrying out the disclosed methods.

### CROSS REFERENCE TO RELATED APPLICATIONS

This application is related to U.S. patent application No. 60/767,407 (Attorney Docket 20052-7001 filed 26 Mar. 2006) and a US utility conversion (Attorney Docket 20052-7003) both titled “POS Advertising System, Method, and Computer Program Product” with the conversion filed concurrently with this application and commonly owned, the disclosures of which are expressly incorporated in their entireties by reference for all purposes.

### BACKGROUND OF THE INVENTION

The present invention relates generally to Point-Of-Sale (POS) systems, and more particularly to real-time advertisement generation with POS Systems.

There are many instances of retail POS systems that generate some type of token, coupon, or advertisement, particularly in the food supermarket context. Various systems exist in this context to provide history-driven discounting, and purchase-driven discounting. In the history-driven systems, a customer “registers” with the system and then a customer profile is created. Each time the customer identifies themselves with the system, such as by using a shopping card having their registration information, the profile is processed using a range of possible algorithms including comparing current purchases to past purchases by quantity, brand, and, product and generates general or specific coupons or tokens.

In a purchase-driven system, a user is not required to register as the system processes the specific group of products and generates appropriate coupons and tokens consistent with the then current advertising algorithm. Still other systems may combine aspects of these different modalities, such as to use a customer card to realize a special pricing on a particular brand of product. A key focus of these systems is that the discount is for a product or service offered by the food supermarket—that is these systems promote the supermarket's own inventory.

There are many other establishments where a POS system is used that could benefit from a properly implemented advertising program tied into its receipt system. These establishments include restaurants (e.g., “fast food” and traditional dining businesses and the like), entertainment facilities (e.g., theme parks, sporting events, theatre/movies, and the like), and retail stores and outlets of all descriptions. In many of these cases, the history-driven discounting model and the purchase-driven discounting model are inapplicable or not particularly compelling to warrant installation and management.

There is believed to be a tremendous opportunity being missed by these establishments in generating customer-value and enhancing revenue by implementing a different advertising model in these situations. In all of them, a receipt is being generated that heretofore is generally viewed as worthless to the purchaser.

What is needed is a system, method, and computer program product to transform receipts from these establishments into a valuable indicia that provides value to both the customer and to the establishment.

### BRIEF SUMMARY OF THE INVENTION

Disclosed is an apparatus, method, system, and computer-program product for producing valuable POS indicia that provides value to both the customer and to the establishment. The apparatus includes a point-of-sale (POS) receipt including a first portion and a second portion, the first portion including a transaction memorialization information and the second portion including a localization token that has been generated, for example, by a process where the time, location and nature of transaction are the parameters used to select the specific contents of the token.

The method includes processes for the manufacture, assembly and use of the disclosed system, with the computer program product including machine-executable instructions for carrying out the disclosed methods.

Real-time localized (e.g., time, geography and the like) POS indicia are realized that enhance both consumer and merchant value. The disclosed materials enable simple, efficient, and economical transformation of receipts from these establishments into valuable indicia that provide value to both the customer and to the establishment.

### BRIEF DESCRIPTION OF THE DRAWINGS

FIG. 1 is an example of a POS receipt including a localization token;

FIG. 2 is an example of the localization token including an alternative content that may be used in the POS receipt shown in FIG. 1; and

FIG. 3 is another example of the localization token including an alternative content that may be used in the POS receipt shown in FIG. 1.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The Nutricate AdServer (NAdS) is designed to download advertisements for incorporation into receipts produced on a restaurant's Point-of-Sale system and is shown and described in the incorporated patent application. (Other variations are contemplated and are within the scope of the present invention—the invention is not limited to these examples.)

Scenario: A foodservice establishment contracts with an advertiser to publish on their customer receipts commercial messages personalized for each customer. The contract might stipulate differing messages for each type of customer as identified by the location of the particular restaurant, the time the meal was purchased and the menu items purchased. The contract may place limits, upper or lower, on impressions in given regions, or at particular restaurants within regions. The contract might stipulate the number of impressions that each category of message can generate. There may be further stipulations of updating the messages and associated graphics with a particular periodicity. And lastly, there may be provisions for periodic updating of all above parameters and syntax.

Management: This contract is parameterized, and stored in the NAdS's Contract database. This may be one of several contracts registered with the NAdS, each uniquely identified, and managed and executed alongside others. Contracts between more than one chain and more than one advertiser may coexist on the same server.

Invocation: As a customer finishes ordering his meal, the counter clerk keys the POS system for a receipt, generating a query to the Nutricate AdServer. The POS identifies itself with a unique identifier; the NAdS queries the POS for location, time-of-service and Purchase Details. For security purposes, an encoded dialog may take place between the two systems before the NAdS accepts the transaction from the POS.

On authentication, the NAdS searches out the appropriate contract, determines the nature and status of the transaction to be executed, and processes the contract parameters with the POS data. The Content Server then generates the appropriate content, and the NAdS transmits the content to the POS or a print server for incorporating into or associating the content with the receipt as the localization token. Registers and servers accumulate data on executed transactions for accounting and billing purposes.

Caching & Security: To optimize latency in printing whilst ensuring security, it may be desirable in some cases to cache some information, parameters and content on the POS itself or on a print server, and to replenish and update it only periodically. This would reduce the number of transactions and traffic between the POS and NAdS.

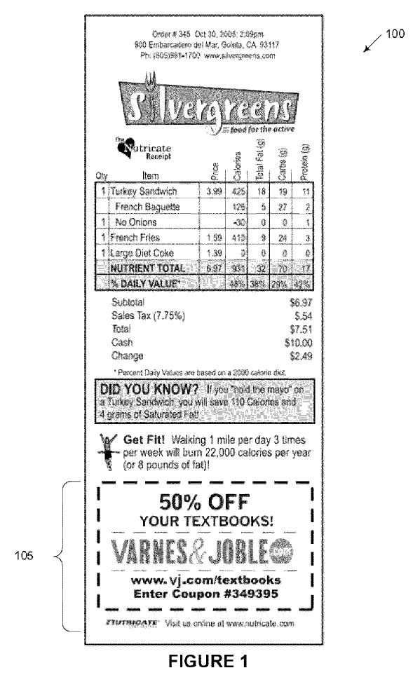

FIG. 1 is an example of a POS receipt 100 including a localization token 105. Token 105 in this example allows for tracking by pointing the customer to a website where a coupon # is needed. In this example, the coupon number is generated dynamically based upon an advertising ruleset used by the system and may be responsive to product(s)/service(s) purchased or otherwise available at the issuing commercial entity. Token 105 is preferably localized, such as for example by use of geographic and/or time-of-day information of a commercial transaction memorializing the provision of the good and/or service. Geographic information may be provided by assigning the POS system with a unique identifier that is used to access a geographic conversion system or the like.

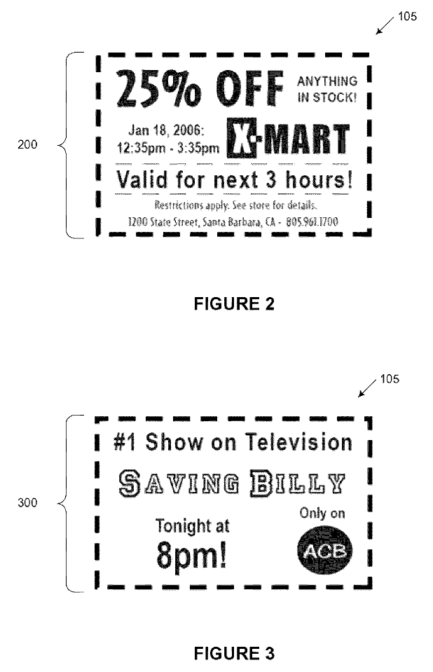

FIG. 2 is an example of localization token 105 including an alternative content 200 that may be used in POS receipt 100 shown in FIG. 1. POS receipt 100 including token 200 is an illustration of an example of time sensitivity knowing that the customer received his/her lunch order at 12:35 pm. Token content 200 is localized in time—and applies some marketing pressure by providing an expiring call-to-action (namely that the customer purchase something at the nearby X-mart within a preset time period after receiving receipt 100). Content 200 takes into consideration localization information (e.g., the location proximity of the commercial entity generating receipt 100 (e.g., a foodservice operator)) to a third party advertiser. In this example the restaurant is located at 1220 State Street, so it would be very convenient for the customer to go to X-Mart after he eats lunch. Optionally, token 200 may include a tracking mechanism (e.g., a bar code or the like not shown). A benefit of a tracking mechanism is it enables revenue sharing for the commercial entity issuing a localization token when it is redeemed.

FIG. 3 is another example of localization token 105 including an alternative content 300 that may be used in POS receipt 100 shown in FIG. 1. Content 300 again demonstrates an ability of POS receipt to provide time sensitivity. In this example, a customer received their receipt at 7:15 pm, so the dynamically adaptive content 300 output information regarding a television show that airs soon thereafter (e.g., at 8PM). Tracking the effectiveness of this content as an advertisement could be performed in several ways, such as for example by measuring a magnitude of a spike in the TV audience in the community that received this ad. Obviously other contents are possible, for example content appropriate for kids such as when kids meals are ordered is available (target/content based on menu item order). Content of token 105 is dynamic and may change with each and every order based upon the advertising ruleset and the appropriate content of the advertising database storing the content as the content is accessed using localized information (e.g., geography and time-of-day). Thus a group of restaurants distributed across a community that all access the same database may now generate different localization content for POS receipts 100 even when the product/service purchased is the same as the location and time may be used to influence/determine the final selected content 105 for each customer for each purchase.

The POS receipt from several types of business establishments neither warrants nor draws much attention. This is especially true of receipts from several types of restaurants, particularly those where the customer orders or selects menu items and pays before consuming the meal. Fast food restaurants and cafeterias fall into this category.

The Nutricate Receipt incorporates onto the receipt nutritional information that is useful and therefore valuable to the consumer. This draws the customer's attention to the receipt, thereby transforming the receipt into an advertising medium. The receipt has been produced at a specific time, at a specific location, and it includes specific details of the consumer's purchase; when this information is made available in real time to an advertiser, a very specific demographic at a very specific time is addressed with a very tightly targeted message.

The restaurant may be an independent restaurant, or a member of a large chain; the advertiser may be a local business, or a nation-wide brand and operation; the advertising contract may be local or nation-wide, short-term or long-term; the message may be static, or generated on-the-fly in real time.

TABLE I

| | | Local | | |
|---|---|---|---|---|
| | Independent | Chain | Regional Chain | National Chain |
| Local Business | X | X | | |
| Regional Brand | X (mediated) | X | X | X (locally) |
| National Brand | X (mediated) | X | X | X |

The implementation technologies may also range widely (for example):

Printer-based: a logic module supplementing the Nutricate Receipt software, with a small repertoire of pre-loaded advertisements resident on the printer. This may be best suited for small chains, and local advertisers, or for sponsorship messages that do not change frequently.

POS-resident: the Nutricate Receipt software extended to an Advertisement module, with programmable business logic drivers for downloadable content. This method could be well-suited to mid-size operations with some IT capability. In addition to development of this module, it would be useful to include tools that small IT departments could use to load and configure this application. A Business Manager module could also be developed, for accounting and administrative functions.

Asp-based Nutricate AdServer: operated as a web-service, such a server would encompass full Campaign Management functionality. The Nutricate customer negotiates a deal with Advertisers, and Nutricate administers and runs the campaign. For each receipt, a time- and location- and consumer-specific advertisement is composed and pushed down to the POS print system (integrated or satellite). Campaigns may be based on number of impressions by time-slot, by receipt content, by area, or by combinations of these factors. This versatility makes the Nutricate AdServer even more valuable in appropriate situations as an advertising method. The concept is easily extended to where a barcode or other customer- or transaction-identifier, could also be printed on the receipt, enabling validated time-sensitive promotions and discounts. In structure, the software may resemble a search engine system (e.g., Google's search- & content-driven AdSense and AdWord), rather than the tracking-based, transaction-oriented Commission Junction model, or ValueClick's arbitrage model.

Asp-based in-house AdServer: a Nutricate AdServer installed in-house is a possibility for large chains that wish to administer and run the advertisement program and contract themselves. The very largest chains with technical depth would be candidates.

Further extensions into loyalty programs and consumer tracking become possible when a “Nutricate Membership” card program is initiated, or a Host's “loyalty” card program is integrated into the Nutricate Receipt and AdServer applications.

Revenue Model

Nutricate's revenue from advertising may be a combination of several components, including without limitation:
Administration fees for the program from advertisers and/or Hosts;
Per-insert fees from advertisers;
% of advertising revenues accruing to Nutricate Hosts;
membership fees from participating retailers, where relevant; and
‘mediation’ fees where the contract between the Host and the advertiser is initiated by Nutricate.

This model could be further modified such that Nutricate, or an associate, owns the real estate on the receipt, and sells that advertising space. In this mode, the restaurant could participate in the revenue stream.

This service platform can be designed cover large or small chains, or even independent restaurants that have little implementation capacity of their own.

Business Use Cases

Sponsorship and Brand Promotion:

This model extends to sponsorship and brand promotion opportunities. An advertiser, say Dole Foods, contracts for a given number of impressions from a variety of single-line copy, e.g. a “Dole Fun Fact: Do you know that 4 oz. of pineapple has . . . ”

The Printer-based and POS- resident extensions to Nutricate Receipt software are good solutions in this case. Several advertisers' campaigns could be simultaneously resident in and operated from even these relatively simple systems.

A retailer, say Target, in contract with, say, Wendy's, offers a discount valid for a few hours after the customer receives a receipt. The receipt carries a discount validation code (or a bar code) and an expiry date and time; this could also enable transaction-driven compensation to the restaurant chain. (This may require a more complex message generation process, like the Nutricate AdServer, especially when multiple locations are involved for the retailer and the restaurant chain.)

Time-specific Media Advertising: A diner at Chilis receives a receipt at 7.30, that carries a message promoting an ABC television show that night at 9.00 pm. (Nutricate AdServers may be designed to specifically cater to such advertising possibilities.)

Location- and time-driven Advertising: A customer orders a meal at Wendy's at 5.30 and receives a receipt with a message promoting a newly-released Disney film playing at an Edwards cinema two blocks down the street. If the order contained a Kid's Meal, Disney's new animation feature could be promoted instead.

This degree of personalized promotion is one area where the Nutricate AdServer really comes into its own, offering a unique revenue potential to the restaurant and a unique promotion opportunity to the advertiser.

As described herein, commercial establishment includes commercial entities individually or collectively, and any or all of such establishments could be networked together and linked by cross-selling relationships, with receipts from each establishment carry advertising messages relating to customer opportunities at other linked establishments. In some of the embodiments described above, a commercial entity generates receipts including localization tokens for other commercial entities as appropriate. The present invention also contemplates and includes and provides for self-promotion for a commercial entity to use the systems, methods, computer program products and propagated signals for their own advertising content on their own receipts. Such as for example driving business with a localization token limited to the “next visit” or other localization techniques as described herein and in the incorporated patent application.

As described above, consumer interest enhancement information may include other types of information different from or in addition to nutritional information (as appropriate for the commercial entity and consumer pool). The embodiments of the present invention include options to directly or loosely couple one or more of the consumer interest enhancement information and/or the advertising content onto the receipt. These optional couplings include different modes of associating the content to the receipt such as direct integration into the receipt, production of an ancillary receipt or generation of a token or other mechanism to retrieve the information through some other communication channel (e.g., download from a computer system or kiosk adapted for this purpose).

The additional information (consumer interest enhancement information and/or the advertising content) is preferably transaction sensitive information responsive to a transaction attribute (e.g., time and/or geographic location and/or other characteristic(s) of the transaction including data regarding the consumer and/or commercial entity and the commercial transaction).

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, and the like.) and as a computer data signal embodied in a computer usable (e.g., readable) transmission medium (e.g., carrier wave or any other medium including digital, optical, or analog-based medium). As such, the software can be transmitted over communication networks including the Internet and intranets, wired, wireless, or hybrid systems. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system, during computer operations. Until required by the computer system, the program instructions may be stored in another readable medium, e.g. in a disk drive, or in a removable memory, such as an optical disk for use in a DVD or CD computer input or in a floppy disk for use in a floppy disk drive computer input or flash drive. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An apparatus, comprising: a point-of-sale (POS) receipt including a first portion and a second portion, said first portion including a transaction memorialization information and said second portion including a localization token.

2. The apparatus of claim 1 wherein said localization token includes an advertising message.

3. The apparatus of claim 2 wherein said advertising message includes graphics and text.

4. The apparatus of claim 2 wherein said advertising message references a commercial activity at an entity generating said POS receipt.

5. The apparatus of claim 2 wherein said advertising message references a commercial activity at a second entity other than a first entity generating said POS receipt.

6. The apparatus of claim 1 wherein said localization token includes a redemption tracking mechanism.

7. The apparatus of claim 1 wherein said localization token includes a time-limited offer.

8. The apparatus of claim 1 wherein said localization token includes a time-sensitive offer.

9. The apparatus of claim 8 wherein said time-sensitive offer identifies a redeeming entity within a twenty-five mile radius of a generating entity issuing said POS receipt.

10. The apparatus of claim 8 wherein said time-sensitive offer identifies a redeeming entity within a two mile radius of a generating entity issuing said POS receipt.

11. The apparatus of claim 8 wherein said time-sensitive offer identifies a redeeming entity within a geographic region defined by one or more zip codes responsive to a zip code of a generating entity issuing said POS receipt.

12. The apparatus of claim 1 wherein said localization token includes an announcement regarding a third-party event.

13. The apparatus of claim 12 wherein said third-party event is an airing of an identified television show.

14. A method, the method comprising:
a) closing a commercial transaction with a transaction sensitive datum; and
b) generating a point-of-sale (POS) receipt of said commercial transaction, said point-of-sale (POS) receipt including a first portion and a second portion, said first portion including a transaction memorialization information and said second portion including a localization token responsive to a transaction attribute of said transaction sensitive datum.

15. The method of claim 14 wherein said transaction sensitive datum includes a transaction location and wherein said transaction attribute includes a geographic identifier.

16. The method of claim 14 wherein said transaction sensitive datum includes a transaction time and wherein said transaction attribute includes a transaction time of day for said transaction time.

17. The method of claim 15 wherein said transaction sensitive datum includes a transaction time and wherein said transaction attribute includes a transaction time of day for said transaction time.

18. A computer program product comprising a computer readable medium carrying program instructions for producing a point-of-sale (POS) receipt when executed using a computing system, the executed program instructions executing a method, the method comprising:
a) closing a commercial transaction with a transaction sensitive datum; and
b) generating a point-of-sale (POS) receipt of said commercial transaction, said point-of-sale (POS) receipt including a first portion and a second portion, said first portion including a transaction memorialization information and said second portion including a localization token responsive to a transaction attribute of said transaction sensitive datum.

19. The computer program product of claim 18 wherein said transaction sensitive datum includes a transaction location and wherein said transaction attribute includes a geographic identifier.

20. The computer program product of claim 18 wherein said transaction sensitive datum includes a transaction time and wherein said transaction attribute includes a transaction time of day for said transaction time.

21. The computer program product of claim 19 wherein said transaction sensitive datum includes a transaction time and wherein said transaction attribute includes a transaction time of day for said transaction time.
